(19) United States
(12) Patent Application Publication
(10) Pub. No.: US 2014/0261741 A1
(43) Pub. Date: Sep. 18, 2014

(54) RAPID-CONNECT COUPLER WITH VENT-HOLES

(71) Applicant: Macro Technologies, LLC, Kirkland, WA (US)

(72) Inventor: Howard M. KONISHI, Kirkland, WA (US)

(73) Assignee: Macro Technologies, LLC, Kirkland, WA (US)

(21) Appl. No.: 14/213,638

(22) Filed: Mar. 14, 2014

Related U.S. Application Data
(60) Provisional application No. 61/785,382, filed on Mar. 14, 2013.

(51) Int. Cl. F16L 37/28

(52) U.S. Cl. CPC F16L 37/28
USPC 137/15.09; 137/798

(57) ABSTRACT

An embodiment includes a coupling system having a rapid-connect coupler configured to engage a male fuel receptacle to convey a fluid. The coupling system may be configured to transition between a coupled configuration and a de-coupled configuration. When transitioning between configurations, significant pressure may build up inside various coupling orifices such that when a disconnection procedure is invoked, the pressure may cause significant forces to push the rapid-connect coupler off of the male receptacle. This may lead to damage and injury. Thus, coupling system may further include vent holes configured to allow pressure inside to be relieved when transitioning from the coupled configuration to the de-coupled configuration.

### PRIORITY CLAM

This application claims the benefit of U.S. Provisional Application No. 61/785,382 filed on Mar. 14, 2013, which application is incorporated herein by reference in its entirety for all purposes.

### RELATED APPLICATION DATA

This application is related to U.S. patent application Ser. No. 13/426377, entitled RAPID-CONNECT COUPLER WITH VENT-STOP filed Mar. 21, 2012, and which is incorporated herein by reference in its entirety.

### BACKGROUND

Cold fluids at cryogenic temperatures (e.g., less than −150° C.) pose special handling problems, principally because the temperature of such fluids may quickly lower the temperature of any valve or coupling through which they flow.

When such a coupling is used to transfer a cryogenic fluid, freeze-up problems may occur if the transfer takes place in a moist or high-humidity environment. Any water within, or immediately outside of, the coupling will quickly freeze, thereby potentially impeding subsequent movement of mechanical parts within the coupling. Moreover, successive transfers from a fluid source with the same pre-chilled coupling half to mating coupling halves communicating with different receptacles at warmer ambient temperatures, have been known to result in freeze-up and leakage because of ice formation at the sealing surfaces.

These problems are present in the area of liquefied natural gas (LNG). In order for LNG to be considered as a viable alternative automotive fuel, it must be easily transferred to the vehicle in which it will be used. In addition, it may be desirable for fuel storage tanks on such vehicles be refilled as quickly as possible. This leads to the prospect of multiple quickly-successive short-duration transfers of LNG, at cryogenic temperatures, between a chilled nozzle and a warm receptacle in a potentially-moist environment.

Additionally, when de-coupling a nozzle and receptacle, there may be gas present between the connection that must be vented as de-coupling occurs. Such remainder gas may be at high pressure, and may cause a forceful de-coupling, which can result in injury to users and equipment.

### SUMMARY

An embodiment of the present disclosure includes a rapid-connect coupling system including a male fueling receptacle configured to convey a fluid. The male fueling receptacle further includes aligned holes near an isolation seal configured to provide protection to the seal when seating and unseating to a rapid-connect coupler body.

### BRIEF DESCRIPTION OF THE DRAWINGS

The present subject matter disclosure will be described by way of exemplary embodiments but not limitations, illustrated in the accompanying drawings in which like references denote similar elements, and in which:

FIG. 1 is a cross section of a coupling system having rapid-connect coupler and a male fueling receptacle in accordance with an embodiment.

FIG. 2 is a cross section of a coupling system having rapid-connect coupler in accordance with an embodiment.

FIG. 3 is a cross section of a male fueling receptacle in accordance with the embodiment.

### DETAILED DESCRIPTION

Illustrative embodiments presented herein include, but are not limited to, systems and methods for providing a rapid-connect gas coupler.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

FIG. 1 is a perspective view of a rapid-connect coupling system 100 in accordance with an embodiment. The system may comprise a male coupling apparatus 201 (male fueling receptacle 201 hereinafter) and a female coupling apparatus 100 (rapid-connect coupler 101 hereinafter). The male fueling receptacle 201 comprises a male coupling body 210, which includes a lip 220, and a recess 225 behind the lip 220. The male coupling body 210 defines a male poppet orifice 230. A male poppet assembly 240 is disposed within the poppet orifice 230.

As discussed herein, the rapid-connect coupler 101 may be operable to couple with the male fueling receptacle 201. For example, the rapid-connect coupler 101 may be placed on the male fueling receptacle 201 while in a first configuration, put into a second configuration to lock the rapid-connect coupler 101 on the male fueling receptacle 201, and then returned to the first configuration to release the rapid-connect coupler 101 from the male fueling receptacle 201.

For example, referring to FIG. 1, the male coupling body 210 is operable to be slidably received within the female coupling orifice 130, and the female poppet assembly 135 is operable to be slidably received within the male poppet orifice 230 such that the female poppet assembly 135 bears against the male poppet assembly 240.

The rapid-connect coupler 101 may generally comprises a first architecture 103, (for example a sleeve 105 as shown in FIG. 1) and a second architecture 102 (for example a ball cage 125 as shown in FIG. 1), which are configured to move relative to each other along a central axis X as further described herein

In this embodiment, the first architecture 102 comprises a sleeve 105, one or more drive pins 110, and a probe assembly 115, which includes a coupling end 120. The one or more drive pins 110 extends through a respective drive slot 140 defined by a portion of the second architecture 103.

The second architecture 103 comprises a ball cage 125, which defines a coupling orifice 130 having a coupling orifice housing 120 and includes one or more balls 145. Within the coupling orifice 130 resides a female poppet assembly 135, which is biased by a poppet assembly spring 180, and the female poppet assembly 135 further comprises a retainer 140, and seal assembly 160. The second architecture 103 further comprises one or more guide pins 150, and a housing barrel 155. In an embodiment, the one or more guide pins 150 may be configured to provide a positive guide the second architecture 103 about the female poppet assembly 135. Additionally, in an embodiment, the second architecture 102 or portions thereof may be removable, and may be configured for easy and swift removal and replacement, which may be required due to damage or maintenance needs.

The second architecture 103 of the rapid-connect coupler 101 further comprises one or more venting holes 104 that are disposed within a venting channel 105. The venting channel 105 may comprise a groove that is formed on the inside of the coupling orifice housing 120 These venting holes 104 may be aligned about the coupling orifice housing 120. In the embodiment shown, there are five pairs of venting holes circumferentially disposed about coupling orifice housing 120 in line with the venting channel 105. Thus, one can see a first pair of venting holes aligned at the top (e.g., at 0 degrees) and at the bottom (e.g., 180 degrees) of the cross sectional view. Additional pairs of venting holes are spaced evenly about the 360 degrees of the coupling orifice housing 120. The venting holes 104 in the rapid connect coupler are discussed in greater detail below.

Similarly, the male coupling body 210 also includes venting holes 221 disposed within a venting channel 222 that is similar to the venting channel 105 of the coupling orifice housing 120. In the embodiment shown in FIG. 1, the male coupling body 210 includes a set of three pairs of aligned holes 221. These holes 221 allow for pressure to be relieved when seating and unseating the male coupling body 210 with the rapid-connect coupler 101. For example, as the male coupling body 210 is received within the female coupling orifice 130, the lip 220 is operable to push the one or more balls 145 outward, and thereby allow the lip 220 to pass past the balls 145. The balls 145 may then be able to fall into or be forced into the recess 225 behind the lip 220. Therefore, the venting holes 221 allow for pressure to be relieved when seating and unseating the male coupling body 210. This allows for an extended life of any seal.

When the rapid-connect coupler 101 is moved to the second configuration, this causes the sleeve 105 to slide over the balls 145, which pushes the balls 145 into the recess 225 behind the lip 220 and then locks the balls 145 in a position wherein the balls 145 extend into the female coupling orifice 130 in the recess 225 of the male coupling body 210. Accordingly, the male coupling body 210 may be locked within the female coupling orifice 130.

Additionally, in such a configuration the male and female poppet 240, 135 may be operable to allow fluid (e.g., liquid natural gas) to pass from the rapid-connect coupler 101 into male coupling body 210. Also, the sealing assembly 160 may be operable to provide a seal by bearing against the interior surface of the male coupling body 210 within the male poppet orifice 230. In an embodiment the sealing assembly 160 may be a two piece seal with an energizing spring.

Additionally, while embodiments of a system 100 as shown in FIG. 1 are disclosed herein, various embodiments may be adapted to couple with a receptacle having other configurations. For example, various embodiments may relate to coupling with male and female receptacles and receptacles having holes, slots, lips, shoulders or threads both internally or externally.

Turning attention to the next figure, FIG. 2 is a cross section of a coupling system 100 having a rapid-connect coupler 101 in accordance with an embodiment. In this embodiment, handles 330A and 330B are rotatably coupled to the housing barrel 156, via a first and second barrel flange 370A, 370B respectively. The handles 330A and 330B are configured to rotate about the a barrel flanges 370A, 370B respectively over a range of motion including coupled and de-coupled configurations In some embodiments, these configurations may be a de-coupled configuration A, a coupled configuration B, and a semi-coupled configuration C.

As the first and second handle 330A, 330B rotate between the A and B configurations, for example, the first architecture 102 and a second architecture 103 move relative to each other along the central axis X. The probe assembly 115 translates within the housing barrel 155, and is biased by a probe spring 165. Additionally, the ball cage 125 is operable to translate within the sleeve 105. For example, FIG. 2 depicts the ball cage 125 extending substantially past the sleeve 105. Additionally, FIG. 2 depicts the ball cage 125 extending substantially past the female poppet assembly 135.

Still referring to FIG. 2, as the handles 330A, 330B may be pulled back from configuration B toward configuration A, the rapid-connect coupler 101 may be operable to generate a positive stop of the handles 330A, 330B at configuration C, which may allow the rapid-connect coupler 101 to vent while in configuration C before returning to configuration A, where the rapid-connect coupler 101 may be released from the male fueling receptacle 201. The positive stop mechanism is described in related patent application Ser. No. 13/426,377 entitled Rapid Connect Coupler with Vent-Stop which is incorporated herein in its entirety.

During the venting, any pressurized buildup of gases or liquid may be expelled from the coupling orifice 130 on the rapid-connect coupler 101 via venting holes 104 and/or from the poppet orifice 230 via the venting holes 221 from the male fueling receptacle 201 side. Accordingly, in an embodiment, the rapid-connect coupler 101 may remain substantially coupled to the male fueling receptacle 201 while in configuration C, but still allow the rapid-connect coupler 101 to vent via vent holes 104 and 221. The venting holes 221 at the male fuel receptacle may be substantially aligned with the venting holes 104 of the rapid-connect coupler so as to assist with allowing pressure to be relieved or may be offset so as to assist with arresting the velocity of escaping gas or liquid. The specific nature and shape of venting holes 104 or 221 is described below with respect to FIG. 3.

FIG. 3 is a cross section of a male fueling receptacle 201 in accordance with the embodiment. Although only the male fueling receptacle 201 cross section is shown here, the skilled artisan understands that the descriptions pf the venting holes 221 may apply equally to venting holes 104 of the rapid-connect coupler 101 as well. As can be seen, three pairs of holes 221 are disposed in the male coupling body 210 about an aperture 395 in a equidistant and uniform manner. The holes 221 are all shown at 60 degrees away from any other hole 221 and all disposed within the venting channel 222. Thus, the pairs are shown at the 0/180 degree pairing, the 60/240 degree pairing and the 120/300 degree pairing. Other configurations are possible that may or may not be equidistant or uniform.

Further, one hole 221 has been shown in an exploded view such that the interior end of the hole 221 is shown to have a recess 390. That is, a groove is formed at the interior end of the venting channel 220 as well as the hole 221 as cut into the male coupling body 210. The recess 390 comprises a first face at a first angle with respect to the aperture 395 and a second face and a second angle with respect to the aperture 395. This recess 390 assists with prolonging the life of the seal when engaged and disengaged over repeated uses during the life of the apparatus. With the venting channel 222, pressure may be relieved more equally through all of the holes 221 simultaneously. This is because a small cavity is formed that surrounds the circumference of the aperture such that each of the venting holes 221 are in fluid communication with each other when sealing and unsealing. In this manner, the venting holes 221 act together as a system with the venting channel as opposed to six separate venting holes 221.

Additionally, although specific embodiments have been illustrated and described herein, it will be appreciated by those of ordinary skill in the art and others, that a wide variety of alternate and/or equivalent implementations may be substituted for the specific embodiment shown and described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

What is claimed is:

1. A coupling apparatus, comprising:
a coupler body having an aperture and configured to convey a fluid; and
a vent apparatus disposed on the aperture of the coupler body and configured to allow fluid inside the coupler body to be evacuated when the coupler body transitions between a coupled configuration to a de-coupled configuration.

2. The coupling apparatus of claim 1, wherein the coupling apparatus comprises a rapid-connect coupler.

3. The coupling apparatus of claim 1, wherein the coupling apparatus comprises a male fueling receptacle.

4. The coupling apparatus of claim 1, wherein the coupler body is configured to couple with a reciprocal coupled body and communicate fluid with the reciprocal coupled body when in a coupled configuration.

5. The coupling apparatus of claim 4, wherein the coupler body is configured to prevent fluid communication between the coupler body and the reciprocal coupled body when in a de-coupled configuration.

6. The coupling apparatus of claim 1, further comprising a plurality of vent holes disposed about the aperture.

7. The coupling apparatus of claim 1, further comprising three pairs of vent holes disposed about the aperture in an equidistant pattern.

8. The coupling apparatus of claim 1, wherein the vent apparatus further comprises a venting channel having a recess set back from the aperture.

9. The coupling apparatus of claim 8, wherein the recess comprises a first face at a first angle with respect to the aperture and a second face and a second angle with respect to the aperture.

10. A rapid-connect coupler system, comprising:
a first coupler having
a first aperture configured to convey a fluid; and
a first vent disposed on the first aperture of the first coupler and configured to allow fluid inside the first coupler to be removed through the first vent when the first coupler transitions between a coupled configuration to a de-coupled configuration; and
a second coupler configured to engage the first coupler body in the coupled configuration

11. The rapid-connect coupler system of claim 10, wherein the first coupler comprises a rapid-connect coupler.

12. The rapid-connect coupler system of claim 10, wherein the first coupler comprises a male fueling receptacle.

13. The rapid-connect coupler system of claim 10, wherein the second coupler comprises:
a second aperture configured to convey the fluid; and
a second vent disposed on the second aperture of the second coupler and configured to allow fluid inside the second coupler to be removed when the second coupler transitions between a coupled configuration to a de-coupled configuration.

14. The rapid-connect coupler system of claim 13, wherein the first vent and the second vent are aligned when in the coupled configuration.

15. The rapid-connect coupler system of claim 13, wherein the second vent is configured to allow fluid inside the first coupler to be removed when the second coupler transitions between a coupled configuration to a de-coupled configuration.

16. The rapid-connect coupler system of claim 10, wherein the first vent comprises three pairs of vent holes disposed about the aperture in an equidistant pattern.

17. The rapid-connect coupler system of claim 16, further comprising a venting channel a recess disposed adjacent to the first aperture such that each of the vent holes are disposed about the venting channel.

18. A method; comprising:
decoupling a rapid-connect coupler from a male fuel receptacle, the rapid-connect coupler and male fuel receptacle forming a pressurized coupling configured to convey fluid from rapid-connect coupler to the male fuel receptacle; and
evacuating fluid from the pressurized coupling through vent holes in male fuel receptacle during the decoupling.

19. The method of claim 18, further comprising:
transitioning the rapid-connect coupler toward a de-coupled configuration from the coupled configuration until a stop apparatus generates a hard-stop at a hard-stop position between the coupled configuration to the de-coupled configuration;
actuating the stop apparatus to release the hard-stop; and
transitioning the rapid-connect coupler from the hard-stop position to the de-coupled configuration.

20. The method of claim 19, wherein the rapid-connect coupler remains engaged with the male fuel receptacle in the hard stop position.

21. The method of claim 18, further comprising preventing communication of fluid between the rapid-connect coupler and the male fuel receptacle when in the de-coupled configuration.

22. The method of claim 18, further comprising evacuating fluid from the pressurized coupling through vent holes in rapid-connect coupler during the decoupling.

23. The method of claim 18, further comprising evacuating fluid from the pressurized coupling through vent holes in rapid-connect coupler during a transition from the de-coupled configuration to a coupled configuration.
